(19) United States
(12) Patent Application Publication
(10) Pub. No.: US 2006/0140294 A1
(43) Pub. Date: Jun. 29, 2006

(54) Block modulation

(75) Inventors: Ari Hottinen, Espoo (FI); Juha Heiskala, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/267,333

(22) Filed: Nov. 7, 2005

Related U.S. Application Data
(60) Provisional application No. 60/625,218, filed on Nov. 5, 2004.

(51) Int. Cl. H04K 1/10

(52) U.S. Cl. 375/260

(57) ABSTRACT

A device for block transmission involving a first number of subcarriers (N), comprising: storage means for storing at least one transmission matrix having a dimension equal to the first number. The transmission matrix being arranged so that the columns of the transmission matrix represent a first transmission characteristic and the rows of the transmission matrix represent a second transmission characteristic. The transmission matrix comprises a second number (k) of block submatrices, each submatrix separated by at least one row and/or column from a further submatrix by a null matrix block.

### REFERENCE TO RELATED APPLICATIONS

This application claims priority of U.S. Provisional Patent Application Ser. No. 60/625,218, filed on Nov. 5, 2004, the contents of which is hereby incorporated by reference.

### FIELD

Embodiments of the invention relate to transmitting information in a wireless communication system. In particular, Embodiments of the invention relate to but is not exclusively for block transmission in a wireless communication system.

### BACKGROUND

A communication system can be seen as a facility that enables communication between two or more entities such as user equipment and/or other nodes associated with the system. The communication may comprise, for example, communication of voice, data, multimedia and so on. The communication system may be circuit switched or packet switched. Furthermore, there may be point-to-point, point-to-multipoint or multipoint-to-point connections. The communication system may be configured to provide wireless communication.

Block transmission refers to transmitting information bearing data in given blocks, where a block contains a fixed or a variable number of symbols or bits. Typically a whole block of symbols needs to be received before it is possible to detect reliably the symbols that were transmitted. In symbol-by-symbol transmission it is possible to detect a transmitted symbol based on a received symbol. Block transmission is used to mitigate effects due to inter-symbol interference (ISI) or, in case of code division, inter-chip interference (ICI) induced by a transmission channel. In transmitting digital data over frequency selective media, inter-symbol interference or inter-chip interference is a major performance limiting factor. Frequency selective media refers to certain frequencies exhibiting significant fading. Frequency selective fading becomes an issue especially for high transmission rates.

Block transmission using orthogonal frequency division multiplexing (OFDM) or code division multiplexing (CDM) waveforms has become popular in current communications systems and in proposals for future communications systems. ODFM is used, for example, in Digital Video Broadcasting—Terrestrial (DVB-T) systems and Wireless Fidelity (WiFi) systems, for example those that meet the IEEE 802.11 specifications. ODFM has also been considered for various future wireless systems. Multicode (CDM) transmission is used in 3G cellular systems, for example in Wideband CDMA (WCDMA) and cdma2000 systems. In addition, various combinations of the above have been proposed, for example multi-carrier CDMA systems which contain frequency-spreading (or precoding) before transmitting the symbols via a subcarrier or subcarriers. Subcarriers are divisions of the carrier capacity, for example the subcarriers of ODFM system are carrier frequencies with overlapping frequency elements, subcarriers of a CDMA system are available codes, and subcarriers of a mimo system can be the different available antenna arrangements.

Both OFDM and CDM systems have their advantages and drawbacks. OFDM has a high peak-to-average power ratio (PAR). PAR results from simultaneous (parallel) transmission of several sub-carriers, and the peak power typically increases as the number of (simultaneously transmitted) summed carriers increases. High PAR typically requires an expensive or complex amplifier and therefore it is of interest to define signaling so that PAR is reduced as much as possible. Furthermore, there are tradeoffs in performance. Namely, due to lack of diversity, the performance of OFDM saturates whenever the outer coding rate is high (above ¾ say).

CDM systems require relatively complex receivers in comparison to OFDM receivers, as unlike OFDM signals they can not be optimally detected with simple operations such as Discrete Fourier Transforms (DFT) or Fast Fourier Transforms (FFT). However CDM or combined CDMA-OFDM distributes the symbol energy over multiple frequency bins increasing frequency diversity therefore producing better performance characteristics over OFDM.

Both systems can be represented by the use of a transmission matrix, which is defined as the matrix a group of symbols is multiplied by to produce the blocks to be transmitted using the subcarriers. One known method for improving the performance of OFDM systems is to precode the input symbol sets prior to multiplication by the transmission matrix.

A precoding method is described in R Danish “Diversity transform for fading Channels”, IEEE Transactions on communications, Vol 44, Issue 12 Dec. 1996, Pages 1653-1661 where real number precoding matrices are used as part of a general diversity transform framework.

Zhiquang Lui et al in “Linear constellation preceding for OFDM with maximum multipath diversity and coding gains” as published in IEEE Transactions for Communications, Vol 51, Issue 3, March 2003, p 416-427 describes an exploitation of a correlation structure of the OFDM sub-channels and performs a subcarrier grouping that splits the set of correlated sub-channels into subsets of less correlated sub-channels. Within each subset of subcarriers, a linear constellation precoder (which can be both complex and nonunitary) is designed to maximize both diversity and coding gains. Liu et al. Claim that their GLCP design applies to any K (number of groups), with modulations QAM (quadrature amplitude modulation), PAM (pulse amplitude modulation), BPSK (binary frequency shift keying), and QPSK (quadrature phase shift keying). The 2×2 (i.e., K=2) and 4×4 (i.e., K=4) preceding matrices have a Vandermonde form as follows:

$$P = \frac{1}{α} [ \begin{matrix}1 & {ⅇ}^{- j \frac{π}{4}} \\ 1 & {ⅇ}^{- j \frac{5 π}{4}}\end{matrix} ]$$

$$and$$

$$P = \frac{1}{α} [ \begin{matrix}1 & {ⅇ}^{- j \frac{π}{8}} & {( {ⅇ}^{- j \frac{π}{8}} )}^{2} & {( {ⅇ}^{- j \frac{π}{8}} )}^{3} \\ 1 & {ⅇ}^{- j \frac{5 π}{8}} & {( {ⅇ}^{- j \frac{5 π}{8}} )}^{2} & {( {ⅇ}^{- j \frac{5 π}{8}} )}^{3} \\ 1 & {ⅇ}^{- j \frac{9 π}{8}} & {( {ⅇ}^{- j \frac{9 π}{8}} )}^{2} & {( {ⅇ}^{- j \frac{9 π}{8}} )}^{3} \\ 1 & {ⅇ}^{- j \frac{13 π}{8}} & {( {ⅇ}^{- j \frac{13 π}{8}} )}^{2} & {( {ⅇ}^{- j \frac{13 π}{8}} )}^{3}\end{matrix} ]$$

respectively, where a is a normalization factor.

An aim of embodiments of the invention is to provide a versatile method for block transmission that eases PAR ratios, and produces known QAM-type constellations in the transmitter, results in a high coding gain and that is easy to decode.

### SUMMARY

There is provided according to the invention a device for block transmission involving a first number of subcarriers (N), comprising: storage means for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

According to a second aspect of the invention there is provided a device for block transmission involving a first number of subcarriers (N), comprising: a memory for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

According to a third aspect of the present invention there is provided a device for block transmission involving a first number of subcarriers (N), comprising: memory for storing at least one transmission matrix comprising a precoding matrix U of the form

$$U ( μ , υ ) = [ \begin{matrix}μ & υ \\ - {υ}^{*} & {μ}^{*}\end{matrix} ] ⊗ {I}_{d / 2} ,$$

wherein μ, ν are parameter values of the precoding matrix.

According to a fourth aspect of the present invention there is provided a modulator for block transmission comprising: an input arranged to receive an input symbol stream; a memory arranged to store at least one transmission matrix comprising a precoding matrix U of the form

$$U ( μ , υ ) = [ \begin{matrix}μ & υ \\ - {υ}^{*} & {μ}^{*}\end{matrix} ] ⊗ {I}_{d / 2} ,$$

wherein μ, ν are parameter values of the preceding matrix; and a processor arranged to multiply the input symbol stream by the transmission matrix to produce an output-symbol stream.

According to a fifth aspect of the present invention there is provided a method for performing a block modulation comprising the steps of: receiving a input symbol stream; generating a transmission matrix from a precoding matrix U of the form

$$U ( μ , υ ) = [ \begin{matrix}μ & υ \\ - {υ}^{*} & {μ}^{*}\end{matrix} ] ⊗ {I}_{d / 2} ,$$

wherein μ, ν are parameter values of the precoding matrix; and multiplying the input symbol stream by the transmission matrix to produce a modulated output symbol stream.

According to a sixth aspect of the present invention there is provided a computer program product arranged to implement a method for performing a block modulation comprising the steps of: receiving a input symbol stream; generating a transmission matrix from a precoding matrix U of the form

$$U ( μ , υ ) = [ \begin{matrix}μ & υ \\ - {υ}^{*} & {μ}^{*}\end{matrix} ] ⊗ {I}_{d / 2} ,$$

wherein μ, ν are parameter values of the precoding matrix; and multiplying the input symbol stream by the transmission matrix to produce a modulated output symbol stream.

According to a seventh aspect of the present invention there is provided a device for block transmission involving a first number of subcarriers (N), comprising: a memory for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

According to an eighth aspect of the present invention there is provided a communications device for performing a block modulation comprising: an input arranged to receive an input symbol stream; a processor arranged to generate a transmission matrix from a precoding matrix U of the form

$$U ( μ , υ ) = [ \begin{matrix}μ & υ \\ - {υ}^{*} & {μ}^{*}\end{matrix} ] ⊗ {I}_{d / 2} ,$$

wherein μ, ν are parameter values of the preceding matrix; and a second processor arranged to multiply the input symbol stream by the transmission matrix to produce a modulated output symbol stream.

### BRIEF DESCRIPTION OF THE DRAWINGS

Embodiments of the invention will now be described by way of example only with reference to the accompanying drawings, in which:

FIG. 1 shows a schematic view of a block diagram of a transmission system as used in embodiments of the present invention,

FIG. 2 shows a schematic view of a flow diagram of a method as employed in a first embodiment of the invention,

FIG. 3 shows symbol correlation matrices relating to known block transmission techniques, OFDM, Single-carrier, Hadamard and to one specific example in accordance with a first embodiment of the invention,

FIG. 4 shows a graph of PER (packet error rate) performance against bit Energy to Noise ratio for an embodiment of the present invention and for a known precoded OFDM system for a five path system,

FIG. 5 shows a graph of PER (packet error rate) performance against Signal to Noise ratio for an embodiment of the invention and for a known precoded OFDM system with a rate ½ outer coding,

FIG. 6 shows a graph of BER (bit error rate) performance against Signal to Noise ratio for an embodiment of the invention and for a known precoded OFDM system with a rate ½ outer coding,

FIG. 7 shows a graph of PER (packet error rate) performance against Signal to Noise ratio for an embodiment of the invention and for a known precoded OFDM system with a rate % outer coding,

FIG. 8 shows a graph of BER (bit error rate) performance against Signal to Noise ratio for an embodiment of the invention and for a known precoded OFDM system with a rate ¾ outer coding,

FIG. 9 shows a graph of PER (packet error rate) performance against Signal to Noise ratio for an embodiment of the present invention and for a known precoded OFDM system with a rate ⅞ outer coding,

FIG. 10 shows a graph of BER (bit error rate) performance against Signal to Noise ratio for an embodiment of the invention and for a known precoded OFDM system with a rate ⅞ outer coding,

FIG. 11 shows a graph of PER (packet error rate) performance against Signal to Noise ratio for a further embodiment of the present invention and for known OFDM systems with a rate % outer coding,

FIG. 12 shows a graph of BER (bit error rate) performance against Signal to Noise ratio for an embodiment of a further embodiment invention and for known OFDM systems with a rate ¾ outer coding,

FIG. 13 shows a graph of PER (packet error rate) performance against Signal to Noise ratio for a further embodiment of the present invention and for known OFDM systems with a rate ⅞ outer coding, and

FIG. 14 shows a graph of BER (bit error rate) performance against Signal to Noise ratio for an embodiment of a further embodiment invention and for known OFDM systems with a rate ⅞ outer coding.

### DETAILED DESCRIPTION OF EMBODIMENTS OF THE INVENTION

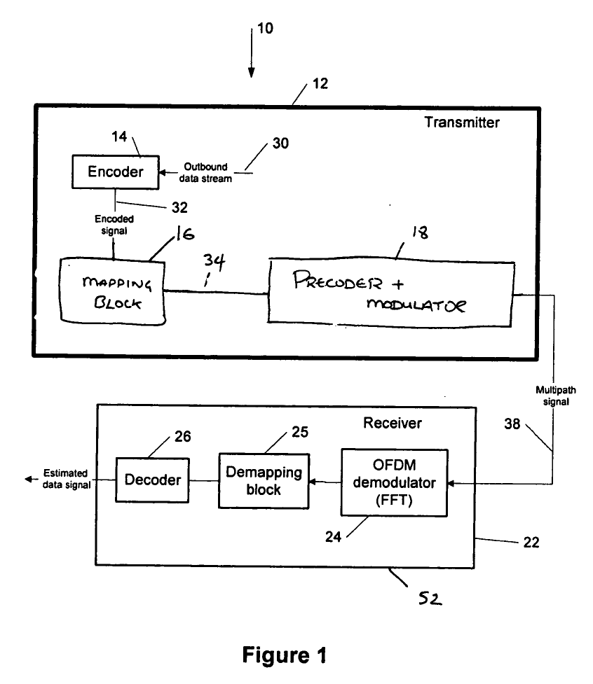

FIG. 1 shows a schematic view of a block diagram for a multichannel transmission system 10, within which an embodiment of the invention can be implemented.

The system comprises a transmitter 12 and a receiver 52 which are connected via a multipath signal environment 38.

Within the transmitter an outbound data stream 30 is initially encoded by a encoder 14 to produce a encoded signal 32. The encoder implements a known forward error code on the outbound data stream. Known FEC codes which can be implemented include low density parity checking (LDPC) codes, Turbo codes, convolutional codes, and ZigZag codes.

The encoder 14 is connected to the mapping block 16 so that the encoded data 32 is passed to the mapping block 16 which maps the encoded signal 32 into a block data stream 34. The mapping block 16 carries out the mapping of the encoded signal 32 using known symbol modulation. For example, by selecting 4 constellation points and the phase shift key modulation a quadrature phase shift keying modulation (QPSK) block format can be produced. The block data stream output from the mapping block 16 to be transmitted can be represented as a vector s=(s₁ . . . s_{N})^{T}, where s₁ to S_{N} represent the encoded data 32 elements. The mapping block 16 is connected to the Precoder and modulator 18 so that the block data stream 34 can be passed to the Precoder and modulator 18.

The block data stream 34 is then precoded and modulated within the modulator (the data stream 34). The preceding process effectively multiplies the block data stream 34 by a Transmission matrix F.

The term transmission matrix refers here to a matrix for processing a block of symbols carrying information to be transmitted. The block of symbols can also be called a set of symbols or a sequence of symbols. Typically a column or a group of distinct columns of a transmission matrix is used for processing symbols relating to a given user or to a given receiving device. Subsets of the block of symbols may be allocated to a number of users or to a number of information streams. The number of symbols in a subset affects the data rate relating to a user or information stream. All symbols belonging to the block of symbols may belong to the same user.

The block of symbols may be considered as a vector and the symbol vector is multiplied in the transmitter with the transmission matrix of appropriate dimension.

By denoting a transmission matrix with F and a block of symbols to be transmitted with a vector s=(s₁, . . . , s_{N})^{T}, the outcome of applying the transmission matrix on the symbol vector produces a transmission vector Fs.

Each element of vector Fs, is thus a linear combination of symbols forming the symbol vector s, the coefficients of the linear combination being defined by the elements of the transmission matrix F. The columns of F designate a transmission characteristic so that for example each column designates a different subcarrier (in conventional OFDM terminology), and each element or coordinate of Fs is typically mapped to a pulse shaping module and converted to designated carrier frequency (not shown). Alternatively, the output Fs may be forwarded to another transmission unit, which may perform, for example, coding, multiple-access, modulation, power control, rate control, or further precoding.

The rows of the vector Fs designate a further transmission characteristic which further controls the application of each column vector value to each of the column transmission characteristics.

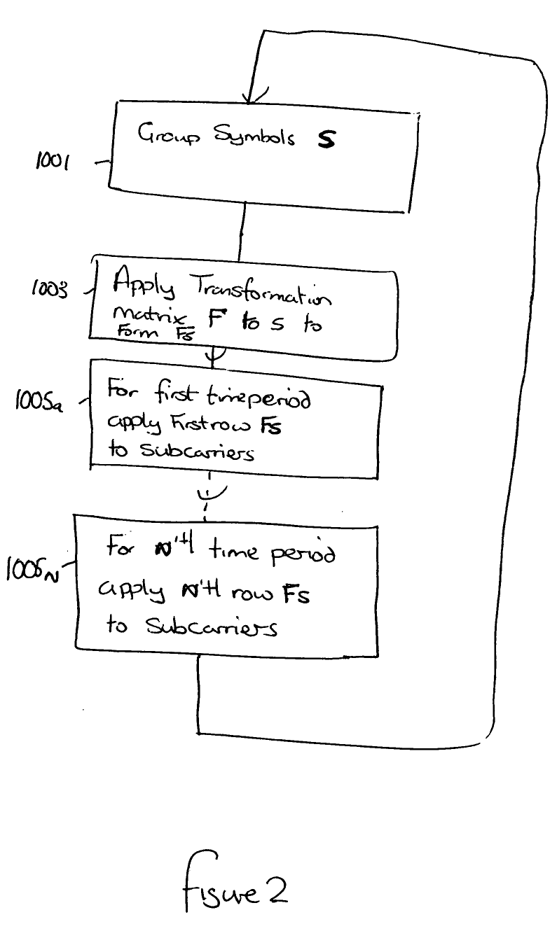

With regards to FIG. 2 a flow diagram which demonstrates the operation of the above apparatus within which embodiments of the present invention may be applied is shown.

The first step 1001 is the grouping of the symbols s₁ to s_{N} into a symbol set or vector s. As described above this is carried out in the mapping block 16.

The next step is the application or multiplication of the Transformation matrix F to the symbol block s to form the vector Fs.

In the following steps 1005a to 1005N the structure of matrix F is defined so vector or product Fs is arranged so that each row of the vector Fs contains the symbols transmitted via different subcarriers or subchannels. For example if matrix F has form FU where U is an orthogonal or a unitary matrix and F an IFFT matrix. The symbols transmitted via subcarriers are formed using the linear combination matrix U, applied to the symbols. The columns of transformation matrix F represent frequency subcarriers and the rows represented discrete time instants, and linearly combined symbols Us are sent via different subcarriers.

The matrix F designates a modulator matrix and matrix U the symbol precoder matrix.

The transformation matrix F (with at least d columns) may thus be decoupled into two parts, F and U.

Where the precoding matrix U is of the form;

$$U ( μ , υ ) = [ \begin{matrix}μ & υ \\ - {υ}^{*} & {μ}^{*}\end{matrix} ] ⊗ {I}_{d / 2}$$

Matrix U has only two non-zero coefficients in each row/column, in order to minimize PAR (peak-to-average ratio) increase and to enable the use of simple receivers. The parameter values of the matrix U are (μ,ν)=(\sqrt{0.8},\sqrt{0.2}). The parameter values of the precoding matrix define the transmitted signal constellation. In the above described system a 4-QAM or QPSK input constellation produces an output (utilizing 2 subcarriers) with a 16-QAM constellation co-ordinate.

The precoder and modulator 18 can be implemented by hardware, software or both. Furthermore, the precoder and modulator 18, the mapping block 16 and other blocks of the transmitter 12 can be integrated on one chip (integrated circuit).

The signal processing on the receiver 22 side is conventional which includes demodulation by a demodulator 24, demapping by a demapping block 25 and decoding by a decoder 26.

As shown in FIG. 1 the transmission matrix is designed to transmit the set of symbols from a single transmitting device. In a single transmitting device system the single transmitting device knows the whole transmission matrix F and the whole symbol vector s. The transmitting device applies the transmission matrix on the symbol vector as described below. If there are a number of transmitters or transmitting devices, each of these units knows at least those columns of the transmission matrix that relate to the subset of symbols the unit is transmitting. The columns are then applied to the subset of symbols to produce partial linear combinations in accordance with the transmission matrix. These partial linear combinations are then transmitted from the plurality of transmitters or transmitting device(s) in accordance with the transmission matrix.

In order to further understand the embodiments of the invention the operation of the precoder and modulator 18 and the transmission matrix F is further described.

The transmission matrix F in the first embodiment of the present invention is a d₁ dimensional square matrix (i.e. the F matrix has d₁ rows and d₁ columns), where d₁ is the number of subcarriers available (code slots, frequency subcarriers etc).

The matrix F is formed from the tensor operations of constituent and unitary matrices as described with respect to equation (1).
F=(Fₐ\textcircled{×}I_{d}_{₁}_{/d}_{₂}_{d}_{₃})\textcircled{×}F_{b} equation (1)
where Fₐ is a d₂ dimensional constituent block transmission matrix, F_{b} is a d₃ dimensional unitary matrix (i.e. a square matrix whose inverse is equal to its conjugate transpose) (and is the precoding matrix) and I is a d₁/d₂/d₃ dimensional identity matrix. The notation \textcircled{×} means a Kronecker product, also known as a direct product or a tensor product.

To assist in the understanding of the invention a couple of known F matrices are described.

The structure of the entries of the transmission matrix F are denoted by the values F_{b}(i, j), where 1<i, j<d₃ which are the (i,j)′th element of the F_{b} matrix. Each matrix F_{b} is multiplied by a scalar Fₐ(i,j). The scalar components are the elements which form the matrix Fₐ. In other words, entries of the multiplier matrix are Fₐ(i, j), where 1<i, j<d₂.

Thus when 1=1 in Equation (1).

$$F = ( \begin{matrix}{F}_{a} ( 1 , 1 ) ( \begin{matrix}{F}_{b} ( 1 , 1 ) & ⋯ & {F}_{b} ( 1 , {d}_{3} ) \\ ⋮ & ⋰ & ⋮ \\ {F}_{b} ( {d}_{3} , 1 ) & ⋯ & {F}_{b} ( {d}_{3} , {d}_{3} )\end{matrix} ) & {F}_{a} ( 1 , 2 ) {F}_{b} & ⋯ & {F}_{a} ( 1 , {d}_{2} ) {F}_{b} \\ {F}_{a} ( 2 , 1 ) {F}_{b} & {F}_{a} ( 2 , 2 ) {F}_{b} & ⋯ & {F}_{a} ( 2 , {d}_{2} ) {F}_{b} \\ ⋮ & ⋮ & ⋰ & ⋮ \\ {F}_{a} ( {d}_{2} , 1 ) {F}_{b} & {F}_{a} ( {d}_{2} , 2 ) {F}_{b} & ⋯ & {F}_{a} ( {d}_{2} , {d}_{2} ) {F}_{b}\end{matrix} )$$

When I has a dimension greater than 1, some of the even-sized blocks of the transmission matrix F are filled with zeros. It is appreciated that the zeros in the following formula represent matrix blocks having the size of matrix F_{b} and being filled with zeros. Thus when I is a 3×3 matrix F=

$$( \begin{matrix}{F}_{a} ( 1 , 1 ) {F}_{b} & 0 & 0 & ⋯ & {F}_{a} ( 1 , {d}_{2} ) {F}_{b} & 0 & 0 \\ 0 & {F}_{a} ( 1 , 1 ) {F}_{b} & 0 & ⋯ & 0 & {F}_{a} ( 1 , {d}_{2} ) {F}_{b} & 0 \\ 0 & 0 & {F}_{a} ( 1 , 1 ) {F}_{b} & ⋯ & 0 & 0 & {F}_{a} ( 1 , {d}_{2} ) {F}_{b} \\ ⋮ & ⋮ & ⋮ & ⋰ & ⋮ & ⋮ & ⋮ \\ {F}_{a} ( {d}_{2} , 1 ) {F}_{b} & 0 & 0 & ⋯ & {F}_{a} ( {d}_{2} , {d}_{2} ) {F}_{b} & 0 & 0 \\ 0 & {F}_{a} ( {d}_{2} , 1 ) {F}_{b} & 0 & ⋯ & 0 & {F}_{a} ( {d}_{2} , {d}_{2} ) {F}_{b} & 0 \\ 0 & 0 & {F}_{a} ( {d}_{2} , 1 ) {F}_{b} & ⋯ & 0 & 0 & {F}_{a} ( {d}_{2} , {d}_{2} ) {F}_{b}\end{matrix} )$$

Two known transmission matrices are conventional OFDM and CDMA multi-code systems. When Fₐ is an IFFT/IDFT matrix, in the absence of precoding matrix U i.e. d₁=d₃=1, the transmission method is a conventional OFDM transmission system. A IFFT/IDFT matrix is a matrix used to perform an inverse fast fourier transform/inverse discrete fourier transform operation on an input vector. When Fₐ is a Hadamard matrix, and d₁=d₃=1 the block transmission method is effectively a CDMA multi-code transmission system. A Hadamard matrix is one where the matrix entries of a n×n Hadamard matrix H are either +1 or −1, and HH^{T}=nI.

These systems as disclosed earlier have advantages and disadvantages as previously described. Furthermore as also described F_{b} matrices with dimension >1 are known for example the Zhiquang Lui method describes specific 2×2 and 4×4 preceding matrices.

In the present invention as embodied by the following examples a transmission matrix is formed which produces as an output a conventional lattice constellation symbol, e.g. equispaced QAM constellation symbol from an input formed from a conventional lattice constellation symbol, e.g. equispaced QAM/QPSK constellation symbol.

In a first embodiment of the present invention the transmission matrix F is formed using the parameters d₃=1 (e.g. F_{b}=1), d₂>1 (e.g. d₂=2), Fₐ is a 2×2 hadamard matrix.

Thus when

$${F}_{a} = ( \begin{matrix}1 & 1 \\ 1 & - 1\end{matrix} ) , {F}_{b} = ( 1 ) , I = ( \begin{matrix}1 & 0 \\ 0 & 1\end{matrix} )$$

$$F = ( \begin{matrix}1 & 0 & 0 & 0 & 1 & 0 & 0 & 0 \\ 0 & 1 & 0 & 0 & 0 & 1 & 0 & 0 \\ 0 & 0 & 1 & 0 & 0 & 0 & 1 & 0 \\ 0 & 0 & 0 & 1 & 0 & 0 & 0 & 1 \\ 1 & 0 & 0 & 0 & - 1 & 0 & 0 & 0 \\ 0 & 1 & 0 & 0 & 0 & - 1 & 0 & 0 \\ 0 & 0 & 1 & 0 & 0 & 0 & - 1 & 0 \\ 0 & 0 & 0 & 1 & 0 & 0 & 0 & - 1\end{matrix} )$$

A transmission matrix of this form produces ‘chip interleaved’ transmission. in other words the non zero elements in columns separated by zeroes is analogous to first spreading a block of symbols and then interleaving subsymbols or chips. The above system produces improved performance characteristics over the conventional ‘chip interleaved’ transmission matrices as described above in multipath environments. In these environments the received signal is not a direct copy of the transmitted signal, but is subject to delay and attenuation. A typical multipath environment is an urban mobile network one where the receiver is not in line of sight of the transmitter and the received signal is typically received after reflecting from many surfaces.

These environments can be modelled by a finite impulse response (FIR) model, in other words that the received signals are copies of the original transmitted signal delayed for up to a finite time period and attenuated by the environment.

It can be seen that in such models the delayed copies of the columns retain orthogonality to at least some of the other columns. In other words the correlation of one column by a time delayed other column is smaller. In such cases where there is orthogonality between delayed columns the interference between the two columns is zero. Thus where described previously each column can represent a user or a separate data stream it is possible to decrease the amount of inter-user or inter-stream interference.

In comparison with the known multi-code CDMA system. In CDMA multi-code systems all of the delayed signals correlate generally with all other signals. Therefore in a CDMA system to a large degree the signals interfere with each other and therefore a complex receiver is required to separate the required signal from the background interference.

In a known OFDM system, it is possible to introduce orthogonality into the columns by using properly defined zero-padding or cyclic prefixes to the system. The disadvantages associated with zero padding and cyclic prefixes are that the signal power variations between streams (or effectively columns) are increased which reduces the diversity benefit (as some of the streams dominate the remainder and therefore reduce the performance rates of the dominated streams).

In a second example of the present invention if d₃=2 (F_{b} is a 2×2 Hadamard matrix), d₂>1 (Fₐ is a 2×2 Hadamard matrix):

Therefore where

$${F}_{a} = ( \begin{matrix}1 & 1 \\ 1 & - 1\end{matrix} ) , {F}_{b} = ( \begin{matrix}1 & 1 \\ 1 & - 1\end{matrix} ) , I = ( \begin{matrix}1 & 0 \\ 0 & 1\end{matrix} )$$

$$F = ( \begin{matrix}1 & 1 & 0 & 0 & 1 & 1 & 0 & 0 \\ 1 & - 1 & 0 & 0 & 1 & - 1 & 0 & 0 \\ 0 & 0 & 1 & 1 & 0 & 0 & 1 & 1 \\ 0 & 0 & 1 & - 1 & 0 & 0 & 1 & - 1 \\ 1 & 1 & 0 & 0 & - 1 & - 1 & 0 & 0 \\ 1 & - 1 & 0 & 0 & - 1 & 1 & 0 & 0 \\ 0 & 0 & 1 & 1 & 0 & 0 & - 1 & - 1 \\ 0 & 0 & 1 & - 1 & 0 & 0 & - 1 & 1\end{matrix} ) = ( \begin{matrix}{F}_{a} ( 1 , 1 ) {F}_{b} & 0 & {F}_{a} ( 1 , 2 ) {F}_{b} & 0 \\ 0 & {F}_{a} ( 1 , 1 ) {F}_{b} & 0 & {F}_{a} ( 1 , 2 ) {F}_{b} \\ {F}_{a} ( 2 , 1 ) {F}_{b} & 0 & {F}_{a} ( 2 , 2 ) {F}_{b} & 0 \\ 0 & {F}_{a} ( 2 , 1 ) {F}_{b} & 0 & {F}_{a} ( 2 , 2 ) {F}_{b}\end{matrix} )$$

In this example the transmission matrix describes a Block interleaved Block Transmission matrix (BIBT). As per the previous embodiment the columns of the transmission matrix are arranged such that the at least some of the delayed columns retain orthogonality to at least some other columns.

In a third example of the invention 16 subcarriers are used. In this example Fₐ is an 8 dimensional IFFT matrix and F_{b} a 2×2 Hadamard matrix. F is represented by.

$$F = ( \begin{matrix}{F}_{a} ( 1 , 1 ) ( \begin{matrix}1 & 1 \\ 1 & - 1\end{matrix} ) & {F}_{a} ( 1 , 2 ) {F}_{b} & ⋯ & {F}_{a} ( 1 , 8 ) {F}_{b} \\ {F}_{a} ( 2 , 1 ) {F}_{b} & {F}_{a} ( 2 , 2 ) {F}_{b} & ⋯ & {F}_{a} ( 2 , 8 ) {F}_{b} \\ ⋮ & ⋮ & ⋰ & ⋮ \\ {F}_{a} ( 8 , 1 ) {F}_{b} & {F}_{a} ( 8 , 2 ) {F}_{b} & ⋯ & {F}_{a} ( {d}_{2} , 8 ) {F}_{b}\end{matrix} )$$

$$Where {F}_{a} is$$

$${F}_{a} = ( \begin{matrix}0 & 0 & 0 & 0 & 0 & 0 & 0 & 0 \\ 0 & \frac{π}{4} & \frac{π}{2} & \frac{3 π}{4} & - π & - \frac{3 π}{4} & - \frac{π}{2} & - \frac{π}{4} \\ 0 & \frac{π}{2} & - π & - \frac{π}{2} & 0 & \frac{π}{2} & π & - \frac{π}{2} \\ 0 & \frac{3 π}{4} & - \frac{π}{2} & \frac{π}{4} & - π & - \frac{π}{4} & \frac{π}{2} & - \frac{3 π}{4} \\ 0 & - π & 0 & - π & 0 & π & 0 & π \\ 0 & - \frac{3 π}{4} & \frac{π}{2} & - \frac{π}{4} & - π & \frac{π}{4} & - \frac{π}{2} & \frac{3 π}{4} \\ 0 & - \frac{π}{2} & - π & \frac{π}{2} & 0 & - \frac{π}{2} & π & \frac{π}{2} \\ 0 & - \frac{π}{4} & - \frac{π}{2} & - \frac{3 π}{4} & - π & \frac{3 π}{4} & \frac{π}{2} & \frac{π}{4}\end{matrix} )$$

Adding a cyclic prefix or zero padding after the block of 16 symbols/chips is typically of similar length with the length of the dominant delay paths in channel impulse response. With cyclic prefix the L first and L last rows of matrix F are identical. This formed by adding (copying) rows to matrix F

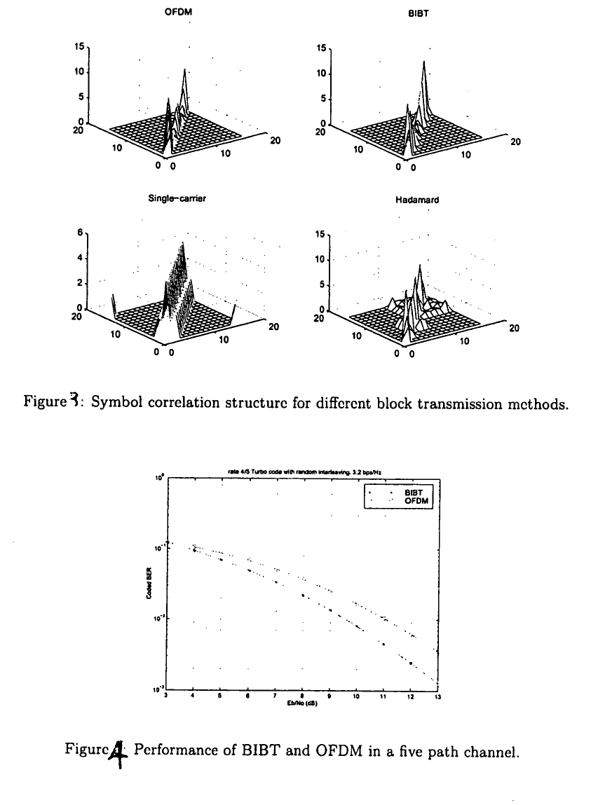

FIG. 3 shows a correlation matrix for the above transmission matrix (the example of the present invention is labelled ‘BIBT’) within which it is possible to show the advantages of the embodiments of the invention and in particular the above example over other known transmission matrices.

The BIBT, OFDM, CDMA and single carrier system were each defined in terms of 16 subcarriers. To create a system with 16 subcarriers in OFDM, the transmission matrix is a 16×16 IFFT matrix. For 16 multi-codes in CDMA, the transmission matrix is a 16×16 Hadamard matrix. For a single carrier system, the transmission matrix is in this form an identity matrix of dimension 16. In precoded OFDM the transmission matrix is comprises a product of IFFT matrix and a precoding matrix.

The improved BIBT delayed correlation matrix decomposes into 8 2×2 correlation matrices. This means that the transmission matrix can be used, for example, for transmitting information relating to 8 users or receivers without having signals relating to different users interfering with each other within a transmission block. This is done by assigning to each user one or more sets of correlating transmission matrix columns. In this specific example, each set of correlating matrix columns, considering matrices and appropriately delayed matrices according to delay spread L, with cyclic prefix of length L, contains two columns. It is possible to use a receiver capable of processing two interfering signals, and the rest of the sent signals need not be taken into account in receiving a signal relating to a specific user.

FIG. 3 shows that for CDMA (without scrambling) the largest block in the correlation matrix is 8×8. This means that a receiver needs to be able to process eight interfering signals. For OFDM, the correlation matrix is diagonal (correlation block size is one), and there is no interference between symbols within a block. The single-carrier case has interference within blocks of five symbols.

FIG. 4 further shows an improvement by using the transmission matrix as shown in the third embodiment over a conventional OFDM system. Both systems used a rate ⅘ turbo code with random interleaving at 3.2 bps/Hz. As can be seen the Improved BIBT system produces coded Bit error rate similar to the conventional OFDM system requiring signal to noise ratios (bit energy to noise ratios) of 1.5 to 2 dB down from the conventional OFDM. (i.e. the Bit error rate for the Improved BIBT system is lower than the conventional OFDM system for the same E_{b}/Nₒ value.

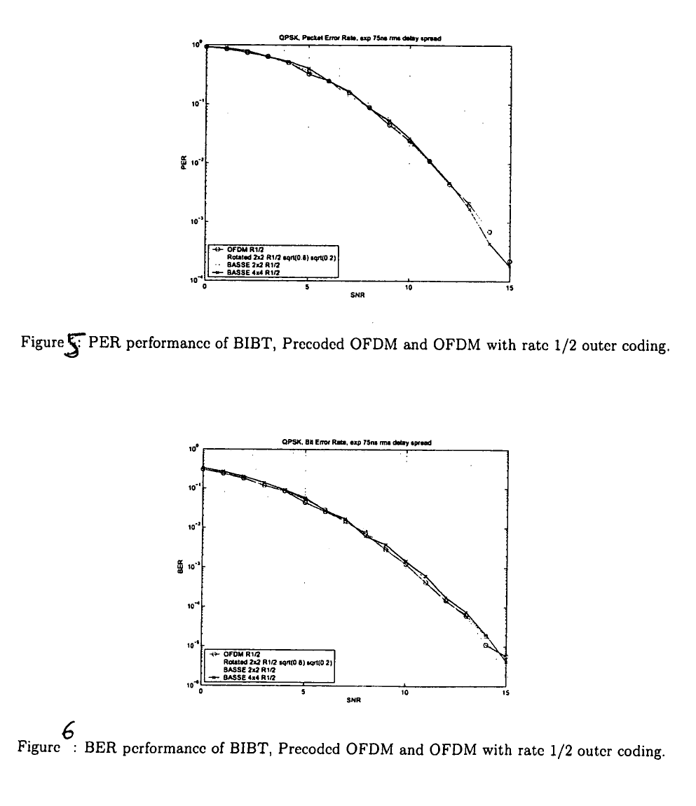

FIGS. 5 to 8 further show the improvement produced by the Improved BIBT system as described in the third embodiment of the present invention over conventional OFDM, Precoded OFDM (where the OFDM code is rotated by a matrix U which is a unitary 2×2 matrix), and against a further Improved BIBT system (labelled as ‘BASSE’) with a higher dimensionality (a 4×4 matrix). The graphs are the result of a simulated wireless local area network environment. The channel estimation for this simulation is perfect and 48 columns of a 64 dimensional basis matrix are used. In other words only 48 columns of the transmission OFDM matrix are used. The matrices used in this example are therefore 64×64 transmission matrices for all but the OFDM system The number of bits per packet is 800.

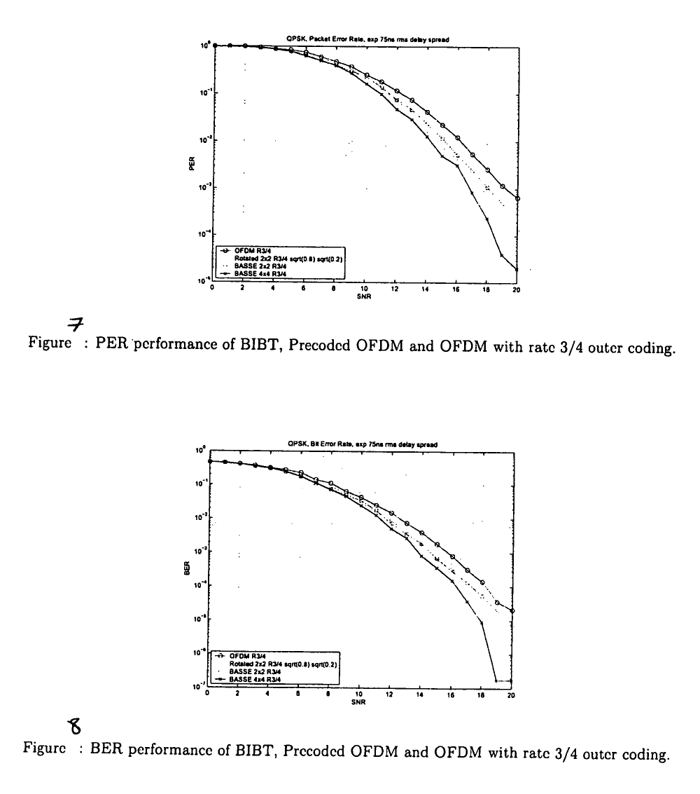

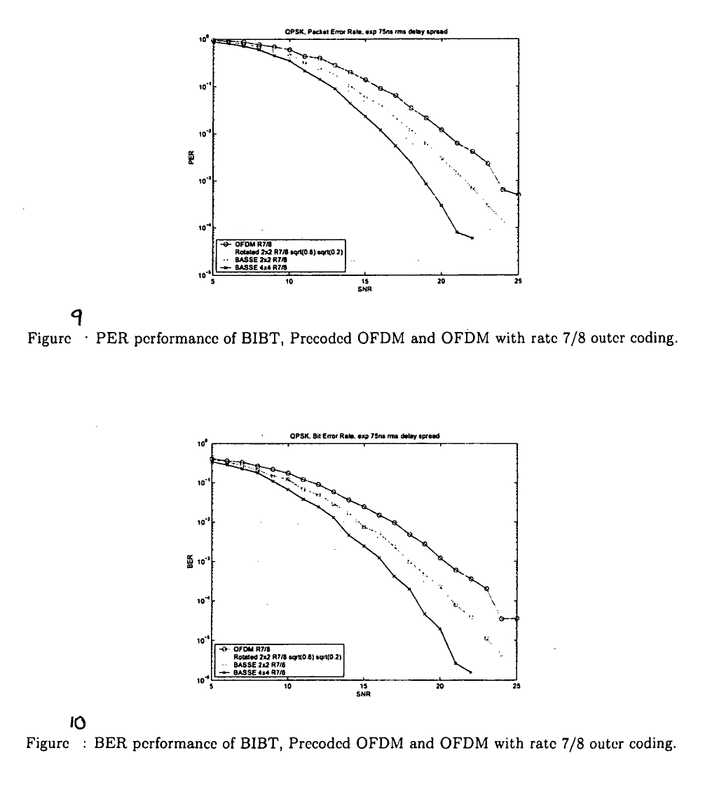

FIGS. 5 and 6 show graphs of Bit Error Rate (BER) and Packet Error Rate (PER) for a QPSK, exp 75 ns exponential delay profile for channel taps, with given delay spread root mean squared (rms) delay spread for ½ rate coded systems. FIGS. 7 and 8 show graphs of BER and PER for ¾ rate coded systems, and FIGS. 9 and 10 show graphs of BER and PER for ⅞ rate coded systems. As can be seen the improved BIBT systems produce an increasingly improved performance over the conventional OFDM as the coding rate is raised. Furthermore it shows that a 4×4 BIBT system (i.e. F_{b} is a 4 dimensional Hadamard matrix) has a further advantage over the rotation precoded OFDM system. However, in the embodiments described above the particular rotation values lead to a simple transmitter (i.e. one capable of broadcasting a 16 QAM symbol constellation coordinate set) and to a receiver that needs to consider only two symbols simultaneously (since U has only two non-zero elements in each row and column)

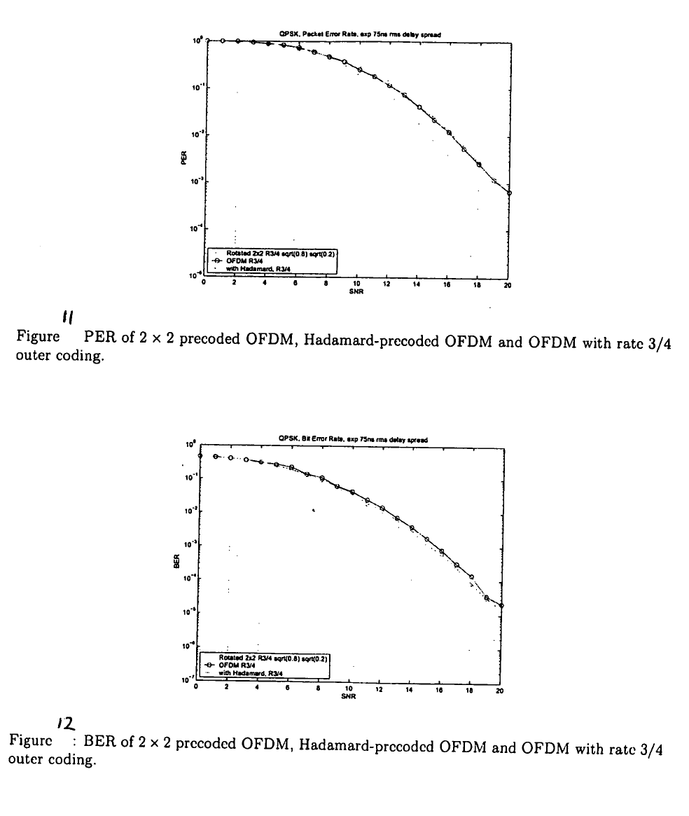

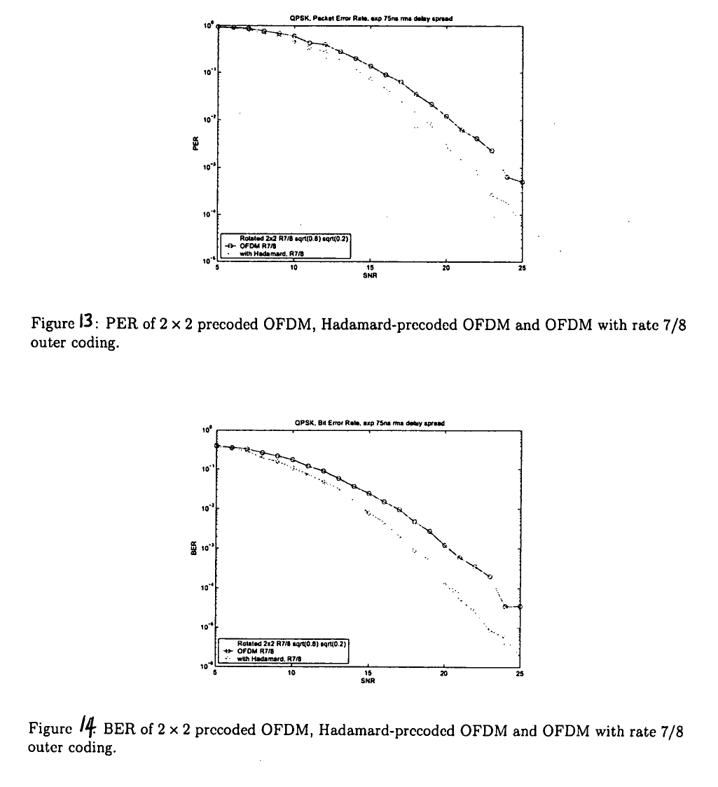

FIGS. 11 to 14 show graphs comparing the Improved BIBT system (labelled as “with Hadamard” in the graph legend), a conventional OFDM system and a rotation precoded OFDM system. FIGS. 11 and 12 show graphs of BER and PER for ¾ rate coded systems, and FIGS. 13 and 14 show graphs of BER and PER for ⅞ rate coded systems. These graphs also show that as the coding rate increases then the improvement from the BIBT system of the present invention increases over the conventional OFDM system.

One of the advantages of the transmission matrix as featured in embodiments of the invention is that the peak-to-average ratio is smaller that in the case where the matrix comprises only non-zero elements, since a smaller number of symbols are summed together in constructing Fs.

In further embodiments of the invention, the multiplier matrix Fₐ is a (complex) scalar multiple of a unitary matrix and can be, for example, a Hadamard matrix, a random matrix or a pseudorandom matrix. The constituent matrix F_{b} may also be, for example, an IFFT matrix, a Hadamard matrix, a random matrix or a pseudorandom matrix. Using these matrices similar advantages can be found.

As described above in some embodiments of the present invention zero padding or cyclic prefix modifications may be added to the transmission matrix F, to either one of matrices Fₐ and F_{b} or to both matrices Fₐ and F_{b}. Furthermore in some embodiments of the present invention F need thus not be a square matrix.

If Fₐ or F_{b} is a random or a pseudorandom matrix, the correlation properties are random, and may change, for example, between different blocks s (that is, between different sets of symbols). This is advantageous when the symbols are coded, for example with some outer code (such as with Turbo coding, convolutional coding, or using low density parity check codes, block codes) Furthermore, it is advantageous to have multiple transmitting devices, for example base stations, with unique Fₐ, F_{b}, or a unique pseudorandom set of Fₐ and F_{b}. This way the interference between different transmitting units is randomised and the base stations or access points may be identified with unique pseudorandom matrices.

It is appreciated that although this description in many places refers, by way of example, to matrices F, Fₐ and F_{b} as square matrices, they need not be square matrices.

As mentioned above, the correlation properties of the transmission matrix may be used in determining which columns of the transmission matrix F to use for which users/receiver/information streams. The correlation properties are typically determined off-line or on-line. Offline typically means using channel models. On-line means using estimated information on channel, for example, on delay spread L. The same L is used in designing the length of cyclic prefix prior art block transmission methods.

The transmitting device 10 may be, for example, a base station in a cellular communications network. In general, it may be any transmitting device configured to transmit signals to one or more receiving devices, including WLAN device or access point or Ultra-wide Band (UWB) transmitter.

It is clear to one skilled in the art that further variations and modifications in the transmitting devices are possible. There may be, for example, a plurality of transmitting devices, each using a set of transmission matrix columns. These transmission devices may be, for example, mobile stations of a cellular communications system. In general, they may be any devices configured to transmit signals.

The receiver needs to know only its own transmission matrix columns, or the columns that are known to be interfering in the given channel with the transmission matrix columns associated with this receiver. As a comparative example, it is noted that in CDMA systems all transmission matrix columns need to be used for optimal reception.

It is appreciated that the sets of symbols to be sent may be sent from one transmitting device, for example from a base station. This means that the columns of the transmission matrix are all used in the base station. Alternatively, the sets of symbols may be sent from a set of antennas. It is possible that each set of processed symbols is sent from a separate antenna. The antennas may belong to one network element or transmitting device, or each antenna may belong to a respective transmitting device. It is, of course, also possible that some transmitting devices have only one antenna and some have more than one antenna. In this case, the number of the transmission matrix columns associated with each transmitting device typically equals the number of antennas in the respective transmitting device.

It is appreciated that the transmission matrix F in Equation 1 does not involve scrambling, which is typically used in communication systems for separating signals sent from different CDMA base station or other corresponding network elements. In further embodiments of the present invention scrambling is added after processing symbols using the transmission matrix F. Scrambling may be implemented, for example, as a transmitting-device-specific or antenna-specific diagonal matrix Λⱼ relating to scrambling. A transmitting device specific transmission matrix Gⱼ would in this case be Gⱼ=ΛⱼF. Alternatively, it is possible that the signals from different transmitting devices or antennas are processed using a set of more general matrices Aⱼ. In this case, Gⱼ=AⱼF. Here A may be an arbitrary, unitary matrix.

It is furthermore possible that the transmission matrix as defined in connection with Equation 1 above is transmitting device or antenna specific. In other words, Fⱼ=(Fₐ\textcircled{×}I)\textcircled{×}F_{b,j}, where there is defined a plurality of matrices F_{b,j}.

It is appreciated that the transmission matrix F defined above in connection with Equation 1 may form a part of a combination matrix used for processing sets of symbols. The combination matrix may be a sum of the transmission matrix F and a further matrix. The further matrix typically relates to block based transmission. Some examples of block-based matrices that may be added up with a transmission matrix F are the following: matrix relating to orthogonal frequency division multiplexing, matrix relating to code division multiplexing, and matrix relating to chip-interleaved block-spread transmission.

Typically a combination matrix of a transmission matrix F and of a further matrix results in a combination matrix where many columns interfere in a transmission channel. Therefore, a reduced set of non-correlating columns may be selected from the combination matrix.

A further modification is that there is defined a sequence of transmission matrices F, and that for consecutive blocks of symbols different transmission matrices are used in accordance with the defined transmission matrix sequence. One example is that the multiplier matrix Fₐ is time dependent. A further example is that the multiplier matrix Fₐ is selected from a set of matrices forming a rotation, i.e. unitary of an orthogonal matrix.

It is appreciated that although a cellular communications system with base stations is mentioned above, the present invention is applicable in any communication system where block-based transmission is used. As further examples, embodiments of the present invention may be applied in wireless local area networks (WLAN), DVB-T, Ultra-wideband communications. Embodiments of the present invention may be applicable to SISO (single-input-single-output) systems and also to SIMO (single-output-multiple-input) systems, to MIMO (multiple-input-multiple-output), or to MISO (multiple-input-single-output) systems.

Furthermore it is also appreciated that although the specification mainly refers to columns of the transmission matrix and to a N times 1 symbol vector, it is clear to a person skilled in the art that similar solutions may employ transpose matrices or other notations for linear algebra.

It is furthermore appreciated that the transmission matrix F that is a direct product of the multiplier matrix, the (optional) identity matrix, and the constituent matrix may be multiplied with unitary matrices before it is applied on the symbol vector. It is also appreciated that the transmission matrix F being a direct product of the given matrixes means does not mean that methods or apparatus involved in applying a transmission matrix in accordance with the invention need to be aware of the constituent matrix Fₐ and/or the multiplier matrix F_{b}. It is sufficient that they are aware of the transmission matrix F and that there in general exist two matrixes Fₐ and F_{b} in accordance with the above description so that the transmission matrix F can be represented as F=(Fₐ\textcircled{×}I)\textcircled{×}F_{b}.

It is appreciated that a computer program as defined in the appended claims may be embodied on a record medium or stored in a memory of a computing device.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A device for block transmission involving a first number of subcarriers (N), comprising:
storage means for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

2. The device as claimed in claim 1, wherein each submatrix is based on a multiplication product of an element of a first matrix and a second matrix.

3. The device as claimed in claim 1, wherein the second matrix is a 2×2 matrix.

4. The device as claimed in claim 1, wherein the second matrix is a Hadamard matrix.

5. The device as claimed in claim 1, wherein the first matrix is one of the following: a Hadamard matrix, a unitary matrix, an inverse Fast Fourier Transform matrix, an inverse Discrete Fourier Transform matrix, a random matrix, and a pseudorandom matrix.

6. The device as claimed in claim 1, wherein said second matrix is a Hadamard matrix and said first matrix is a unitary matrix.

7. The device as claimed in claim 1, wherein at least a part of a first transmission matrix is applied to at least a first subset of said set of symbols and at least a part of a second transmission matrix is applied to at least a second subset of said set of symbols, the first transmission matrix relating to a different second matrix than the second transmission matrix.

8. A device for block transmission involving a first number of subcarriers (N), comprising:
a memory for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

9. A device for block transmission involving a first number of subcarriers (N), comprising:
memory for storing at least one transmission matrix comprising a precoding matrix U of the form
$$U ( μ , υ ) = [ \begin{matrix}μ & υ \\ - {υ}^{*} & {μ}^{*}\end{matrix} ] ⊗ {I}_{d / 2} ,$$
wherein μ, ν are parameter values of the preceding matrix.

10. A device as claimed in claim 9, wherein the parameter values are (μ,ν)=(\sqrt{0.8},\sqrt{0.2}).

11. A device as claimed in claim 10, wherein the device is arranged to receive an input symbol stream and multiply the input symbol stream by the transmission matrix to produce an output symbol stream.

12. A device as claimed in claim 11, wherein the input symbol stream is a Quadrature Phase Shift Keyed (QPSK) symbol stream and the modulated output symbol stream is a 16 element Quadrature Amplitude Modulation symbol stream.

13. A device as claimed in claim 12, wherein the input symbol stream is a 4 element Quadrature Amplitude Modulation (4-QAM) symbol stream and the modulated output symbol stream is a 16 element Quadrature Amplitude Modulation (16-QAM) symbol stream.

14. A communications system comprising at least one device of claim 8.

15. A modulator for block transmission comprising:
an input arranged to receive an input symbol stream;
a memory arranged to store at least one transmission matrix comprising a precoding matrix U of the form
$$U ( μ , υ ) = [ \begin{matrix}μ & υ \\ - {υ}^{*} & {μ}^{*}\end{matrix} ] ⊗ {I}_{d / 2} ,$$
wherein μ, ν are parameter values of the preceding matrix; and
a processor arranged to multiply the input symbol stream by the transmission matrix to produce an output symbol stream.

16. A modulator as claimed in claim 15, wherein the parameter values are (μ,ν)=(\sqrt{0.8},\sqrt{0.2}).

17. A communications system comprising at least one modulator of claim 15.

18. A method for performing a block modulation comprising the steps of:
receiving a input symbol stream;
generating a transmission matrix from a precoding matrix U of the form
$$U ( μ , υ ) = [ \begin{matrix}μ & υ \\ - {υ}^{*} & {μ}^{*}\end{matrix} ] ⊗ {I}_{d / 2} ,$$
wherein μ, ν are parameter values of the preceding matrix; and
multiplying the input symbol stream by the transmission matrix to produce a modulated output symbol stream.

19. A computer program product arranged to implement a method for performing a block modulation comprising the steps of:
receiving a input symbol stream;
generating a transmission matrix from a precoding matrix U of the form
$$U ( μ , υ ) = [ \begin{matrix}μ & υ \\ - {υ}^{*} & {μ}^{*}\end{matrix} ] ⊗ {I}_{d / 2} ,$$
wherein μ, ν are parameter values of the preceding matrix; and
multiplying the input symbol stream by the transmission matrix to produce a modulated output symbol stream.

20. A device for block transmission involving a first number of subcarriers (N), comprising:
a memory for storing at least one transmission matrix having a dimension equal to the first number, the transmission matrix arranged so that the columns of the transmission matrix represent a first transmission characteristic and the rows of the transmission matrix represent a second transmission characteristic; and wherein the transmission matrix comprises a second number (k) of block submatrices, each submatrix separated by at least one row and/or column from a further submatrix by a null matrix block.

21. A communications device for performing a block modulation comprising:
an input arranged to receive an input symbol stream;
a processor arranged to generate a transmission matrix from a precoding matrix U of the form
$$U ( μ , υ ) = [ \begin{matrix}μ & υ \\ - {υ}^{*} & {μ}^{*}\end{matrix} ] ⊗ {I}_{d / 2} ,$$
wherein μ, ν are parameter values of the precoding matrix; and
a second processor arranged to multiply the input symbol stream by the transmission matrix to produce a modulated output symbol stream.

22. A communications device as claimed in claim 21, wherein the first processor and the second processor are the same.
